(19) United States
(12) Patent Application Publication
(10) Pub. No.: US 2025/0338084 A1
(43) Pub. Date: Oct. 30, 2025

(54) METHOD, DEVICE AND COMPUTER STORAGE MEDIUM OF COMMUNICATION

(71) Applicant: NEC CORPORATION, Tokyo (JP)

(72) Inventors: Zonghui XIE, Beijing (CN); Gang WANG, Beijing (CN)

(73) Assignee: NEC CORPORATION, Tokyo (JP)

(21) Appl. No.: 18/998,370

(22) PCT Filed: Jul. 26, 2022
(86) PCT No.: PCT/CN2022/108017

§ 371 Date: Jan. 24, 2025

(51) Int. Cl. H04W 4/02; H04W 84/04

(52) U.S. Cl. CPC H04W 4/025; H04W 84/042

(57) ABSTRACT

Embodiments of the present disclosure relate to methods, devices and computer readable media for communication. A terminal device determines that a location verification for the terminal device is to be performed, and initiates at least one of a first determination of a RAT-dependent location or a second determination of a RAT-independent location. In this way, location information reported by a terminal device may be ensured to be verified by a network.

### FIELD

Embodiments of the present disclosure generally relate to the field of telecommunication, and in particular, to methods, devices and computer storage media of communication for verification of a location of a terminal device.

### BACKGROUND

As known, a feature of being able to locate a terminal device is essential for a non-terrestrial network (NTN) to comply with national regulations in order to obtain a license to operate. This requires being able to determine a location of a terminal device with sufficient accuracy through trusted means. Unfortunately, a location determined by a terminal device through its global navigation satellite system (GNSS) capability cannot be trusted by a network. Thus, the network is expected to have capability to determine a location of a terminal device in an independent manner. It has been proposed to be study and evaluate a solution for a network to verify location information reported by a terminal device. However, such solution is still incomplete and needs to be further developed.

### SUMMARY

In general, embodiments of the present disclosure provide methods, devices and computer storage media of communication for verification of a location of a terminal device.

In a first aspect, there is provided a method of communication. The method comprises: determining, at a terminal device, that a location verification for the terminal device is to be performed; and initiating at least one of a first determination of a radio access technology-dependent location or a second determination of a radio access technology-independent location.

In a second aspect, there is provided a method of communication. The method comprises: determining, at a network device, a radio access technology-dependent location for a terminal device; determining a radio access technology-independent location for the terminal device; and performing a location verification for the terminal device based on the radio access technology-dependent location and the radio access technology-independent location.

In a third aspect, there is provided a terminal device. The device comprises a processor configured to perform the method according to the first aspect of the present disclosure.

In a fourth aspect, there is provided a network device. The device comprises a processor configured to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which some embodiments of the present disclosure can be implemented;

FIG. 2 illustrates a schematic diagram illustrating a process of communication for a location verification according to some embodiments of the present disclosure;

FIG. 3A illustrates a schematic diagram illustrating an example process of location verification according to some embodiments of the present disclosure;

FIG. 3B illustrates a schematic diagram illustrating an example process of location verification according to some embodiments of the present disclosure;

FIG. 3C illustrates a schematic diagram illustrating an example process of location verification according to some embodiments of the present disclosure;

FIG. 4A illustrates a schematic diagram illustrating an example process of location verification according to some embodiments of the present disclosure;

FIG. 4B illustrates a schematic diagram illustrating an example process of location verification according to some embodiments of the present disclosure;

FIG. 4C illustrates a schematic diagram illustrating an example process of location verification according to some embodiments of the present disclosure;

FIG. 4D illustrates a schematic diagram illustrating an example process of location verification according to some embodiments of the present disclosure;

FIG. 4E illustrates a schematic diagram illustrating an example process of location verification according to some embodiments of the present disclosure;

FIG. 4F illustrates a schematic diagram illustrating an example process of location verification according to some embodiments of the present disclosure;

FIG. 4G illustrates a schematic diagram illustrating an example process of location verification according to some embodiments of the present disclosure;

FIG. 5 illustrates a schematic diagram illustrating a process for initial verification according to embodiments of the present disclosure;

FIG. 6 illustrates an example method of communication implemented at a terminal device in accordance with some embodiments of the present disclosure;

FIG. 7 illustrates an example method of communication implemented at a network device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” may refer to a core network (CN) device or an access network device. The term “CN device” refers to any device or entity that provides access and mobility management function (AMF), session management function (SMF), user plane function (UPF), a location management function (LMF), etc. In other embodiments, the CN device may be any other suitable device or entity providing any other suitable functionality.

As used herein, the term “access network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25GHz to 71GHz), frequency band larger than 100GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

Currently, solutions combining both UE reported GNSS information and network based information for verification of UE location are related to the following aspects:
Services subject to national regulations or other operational constraints (e.g., Public Warning System (PWS), Lawful interception (LI), Emergency services (EMS), Charging and Tariff notifications);
Cases where the UE reported location information (for example, determined with its GNSS receiver) could be erroneous due to intentional (e.g. maliciously tampering by user or by the third party) or unintentional (e.g. interference) causes; and
NTN radio cells larger than terrestrial network radio cells and possibly covering borders between two or more countries. Thus, reliability of core network selection in NTNs needs to be improved.

In view of this, embodiments of the present disclosure provide a solution of communication for location verification so as to solve the above and other potential problems. In this solution, a terminal device determines whether a location verification for the terminal device is to be performed. If the location verification is to be performed, the terminal device initiates at least one of determination of a radio access technology (RAT)-dependent location or determination of a RAT-independent location. A network device determines or obtains the RAT-dependent location and the RAT-independent location, and performs the location verification for the terminal device based on the RAT-dependent location and the RAT-independent location. In this way, location information reported by a terminal device may be ensured to be verified by a network.

Principle and example embodiments of the present disclosure will be described in detail below with reference to the accompanying drawings.

In the following, a satellite will be used as an example of an access network device for describing some specific example embodiments of the present disclosure. It is noted that example embodiments described with regard to the satellite are equally applicable to any other suitable types of an access network device.

In the context of the present disclosure, the term “RAT-dependent positioning” or “RAT-dependent positioning method” may refer to any of the following: NR enhanced cell identity (ID) methods (NR E-CID) based on NR signals; Multi-Round Trip Time Positioning (Multi-RTT based on NR signals); Downlink Angle-of-Departure (DL-AoD) based on NR signals; Downlink Time Difference of Arrival (DL-TDOA) based on NR signals; Uplink Time Difference of Arrival (UL-TDOA) based on NR signals; or Uplink Angle-of-Arrival (UL-AoA), including Azimuth-Angle of Arrival (A-AoA) and Zenith Angles of Arrival (Z-AoA) based on NR signals.

In the context of the present disclosure, the term “RAT-dependent location” may refer to a location determined based on the RAT-dependent positioning method. The term “RAT-independent location” may refer to any of the following: GNSS coordinates (e.g., X most significant bit (MSB) bits out of 24 bits of longitude/latitude or GNSS coordinates with ˜X km accuracy (coarse or finer)); V2X like zone ID; virtual cell identifier; or a cell global identity (CGI) of a detected terrestrial network (TN) cell.

### EXAMPLE OF COMMUNICATION NETWORK

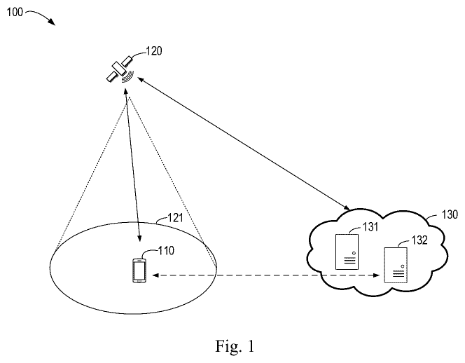

FIG. 1 shows an example communication environment 100 in which example embodiments of the present disclosure can be implemented. The network environment 100 includes a terminal device 110 and an access network device 120. The access network devices 120 may provide one or more serving cells for serving one or more terminal devices. In the example of FIG. 1, the access network device 120 provides a serving cell 121. For convenience, the following description will be given by assuming that the terminal device 110 is located in the serving cell 121 and served by the access network device 120.

As shown in FIG. 1, the network environment 100 may further comprise a CN 130. The CN 130 may comprise a plurality of CN devices. The plurality of CN devices may implement any suitable functionality. The plurality of CN devices may comprise access and mobility management function (AMF) 131 and LMF 132 as illustrated in FIG. 1. It is to be understood that the AMF 131 and the LMF 132 are merely examples, and any other suitable CN devices having similar functionalities are also feasible. For illustration, the following description will be given in connection with the AMF 131 and the LMF 132. It is to be understood that the AMF 131 may be implemented by any suitable CN device having access and mobility management function, and the LMF 132 may be implemented by any suitable location server.

In case that the terminal device 110 is within the serving cell 121 generated from the access network device 120 (i.e., the satellite), a service link refers to a radio link between the terminal device 110 and the access network device 120. A feeder link refers to a radio link between the access network device 120 and the gateway 130. Communication in a direction from a terminal device 110 towards the access network device 120 and further to the gateway 130 is referred to as uplink communication, while communication in a reverse direction from the access network device 120 towards the terminal device 110 is referred to as downlink communication.

In the example of FIG. 1, the terminal device 110 may be in different states (such as, connected state, inactive state and idle state) and also may operate on a power saving mechanism including but not limited to discontinuous reception (DRX), enhanced DRX (eDRX), power saving mode (PSM), relaxed monitoring and so on.

The communications in the communication environment 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers and their connections of access network device, terminal device, CN device, CN and serving cell are only for the purpose of illustration without suggesting any limitations. The communication environment 100 may include any suitable access network device, terminal device, CN device, CN and serving cell adapted for implementing embodiments of the present disclosure. Although not shown, it is to be understood that one or more additional network devices may comprised in communication environment 100, such as, a terrestrial station, a gateway and so on.

In some scenarios, the terminal device 110 may report location information (e.g., RAT-independent location) of the terminal device 110 to a network. The network may verify the location information. In some embodiments, the access network device 120 may verify the location information. In some embodiments, a CN device such as the AMF 131 may verify the location information. However, maintenance of the verification and initiation of the verification are still unclear.

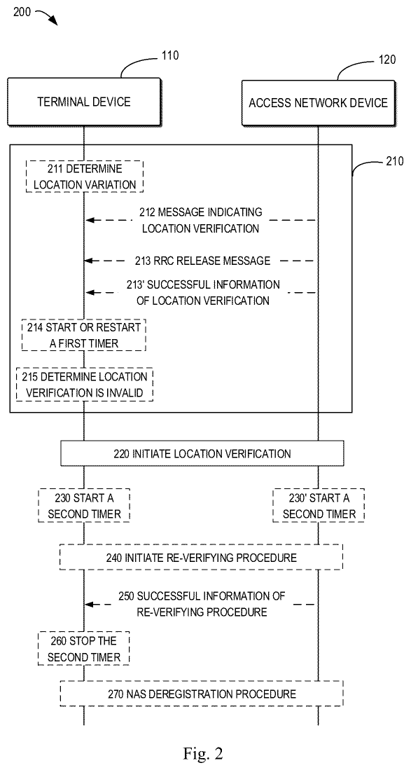

Embodiments of the present disclosure provide a solution of communication for a location verification so as to overcome the above and other potential issues. More details will be described below in connection with FIG. 2.

### EXAMPLE IMPLEMENTATION OF LOCATION VERIFICATION

FIG. 2 illustrates a schematic diagram illustrating a process 200 of communication for a location verification according to embodiments of the present disclosure. For the purpose of discussion, the process 200 will be described with reference to FIG. 1. The process 200 may involve the terminal device 110 and the access network device 120 as illustrated in FIG. 1. It is to be understood that an order of steps in the process 200 is merely for example and the present disclosure does not make limitation on the order.

As shown in FIG. 2, the terminal device 110 may determine 210 whether a location verification for the terminal device 110 is to be performed.

In some embodiments, the terminal device 110 may determine 211 whether a variation of a location of the terminal device 110 exceeds (e.g., greater than or equal to) a threshold variation. If the variation of the location of the terminal device 110 exceeds the threshold variation, the terminal device 110 may determine that the location verification is to be performed.

For example, if a moving distance of the terminal device 110 exceeds a threshold distance, the terminal device 110 may determine that the location verification is to be performed. In another example, if a variation of at least one of longitude, latitude or altitude of the terminal device 110 exceeds a predetermined variation, the terminal device 110 may determine that the location verification is to be performed. In still another example, if the terminal device 110 enters a predefined area (for example, geographical regions, tracking areas or cells signaled by the access network device 120), the terminal device 110 may determine that the location verification is to be performed.

In some embodiments, if a message indicating the location verification is received 212 from the access network device 120, the terminal device 110 may determine that the location verification is to be performed. In some embodiments where the terminal device 110 is in an idle or inactive state, the terminal device 110 may receive, from the access network device 120, a paging message indicating the location verification (for example, a paging message with a paging record comprising a paging cause that indicates the location verification).

In some embodiments, a timer (for convenience, also referred to as a first timer herein) may be configured for validity of the location verification. In some embodiments, if a radio resource control (RRC) release message is received 213 from the access network device 120, the terminal device 110 may start or restart 214 the first timer.

In some embodiments, the terminal device 110 may receive information of the location verification from the access network device 120. In some embodiments, the terminal device 110 may receive unsuccessful or successful information of the location verification. In some embodiments, verified status may be indicated to the terminal device 110 every time.

In some embodiments, the terminal device 110 may receive only unsuccessful information of the location verification. In some embodiments where the terminal device 110 is in a connected state, the terminal device 110 may receive only unsuccessful information of the location verification. In some embodiments, upon entering an idle or inactive state, the terminal device 110 may receive an indication of remaining time in which the location verification is valid. In some embodiments, the terminal device 110 may receive a RRC release message comprising the indication of the remaining time.

In some embodiments, if successful information of the location verification is received 213′ from the access network device 120, the terminal device 110 may start or restart 214 the first timer. In other words, the first timer may be started or restarted upon the last updating of location verification (i.e., when the terminal device 110 is indicated as trustable).

In some embodiments, a value of the first timer may be configured in the RRC release message. It is to be understood that the value of the first timer may be determined in any other suitable ways.

In some embodiments, if the first timer expires, the terminal device 110 may determine 215 that the location verification is invalid. Then the terminal device 110 may determine that the location verification is to be performed. In other words, upon expiry of the first timer, the terminal device 110 may initiate a further location verification (i.e., a location re-verifying procedure). In some embodiments, the value of the first timer may be set to a valid time configured by the network device 120. In some embodiments, the terminal device 110 will initiate a location verification if a period of time equal to or more than a predefined time have passed since location verification were last performed.

Continue to refer to FIG. 2, if the location verification is to be performed, the terminal device 110 may initiate 220 the location verification.

In some embodiments, the terminal device 110 may initiate a determination (for convenience, also referred to as a first determination herein) of a RAT-dependent location. In other words, the terminal device 110 may initiate a RAT-dependent positioning. In some embodiments, the terminal device 110 may perform location measurements for a RAT-dependent positioning procedure, and transmit results of the location measurements to the network.

In some embodiments, the terminal device 110 may initiate a determination (for convenience, also referred to as a second determination herein) of a RAT-independent location. That is, the terminal device 110 may initiate a RAT-independent location delivery. In some embodiments, the terminal device 110 may transmit a RAT-independent location to the network.

It is to be understood that, in some embodiments, the terminal device 110 may initiate both the RAT-dependent positioning and the RAT-independent location delivery for the location verification.

In some embodiments, the RAT-dependent positioning may be triggered by the RAT-independent location delivery. In some embodiments where the terminal device 110 is in a connected state, if a RAT-independent location is to be reported, the terminal device 110 may determine whether a location verification is valid. If the location verification is invalid, the terminal device 110 may determine that the location verification is to be performed. In some embodiments, the terminal device 110 may initiate a RAT-dependent positioning. In this way, a RAT-dependent positioning may be triggered by a RAT-independent location delivery or reporting.

In some embodiments, the terminal device 110 may determine to report a RAT-independent location to a network based on a radio resource management (RRM) measurement. For example, an example procedure may be described as below.
if the coarseLocationRequest is set to true in the corresponding reportConfig for this measId:
   if available, include coarseLocationInfo;
      if the UE location verification is indicated as invalid
         (Indicated higher layer to) initiate RAT-dependent positioning procedure.

In some embodiments, the terminal device 110 may receive, from a network, an UE information request message for obtaining a RAT-independent location, and transmit the RAT-independent location to the network as a response to the UE information request message. For example, an example procedure may be described as below.
Upon receiving a UEInformationRequest message, the UE shall, only after successful security activation:
if the coarseLocationRequest is set to true:
   if available, include coarseLocationInfo;
      if the UE location verification is indicated as invalid
         (indicated higher layer to) initiate RAT-dependent positioning procedure.

In some embodiments, the terminal device 110 may receive, from a network, a measurement configuration comprising an event for triggering a location verification. In some embodiments, the event may comprise at least one of the following: the moving distance exceeds the threshold distance; the variation of at least one of longitude, latitude or altitude exceeds the threshold variation; the terminal device enters the predefined area; or the first timer expires. It is to be understood that any other suitable events are also feasible. In some embodiments, upon triggering of the event, a RRC layer of the terminal device 110 may initiate a RAT-independent location delivery via a measurement report and initiate a RAT-dependent positioning. In some embodiments, the RRC layer of the terminal device 110 indicates a higher layer of the terminal device 110 to initiate the RAT-dependent positioning.

In the context of the present disclosure, the term “location verification” refers to performing a location verification procedure. The term “further location verification” or “location re-verifying procedure” refers to performing the location verification procedure again. The term “location verification procedure” refers to initiating at least one of the first or second determination, i.e., triggering at least one of RAT-dependent positioning or RAT-independent location delivery.

In some embodiments, a network may acquire a RAT-dependent location of a terminal device and use the RAT-dependent location to verify a RAT-independent location of the terminal device reported in a period of time. In other words, the network may maintain validity of a RAT-dependent location. If the RAT-dependent location is invalid or out of date, a location of a terminal device will be considered as un-trustable. In this case, a RAT-dependent positioning may be initiated. For illustration, some example embodiments will be described in connection with Embodiments 1 to 3.

### EMBODIMENT 1

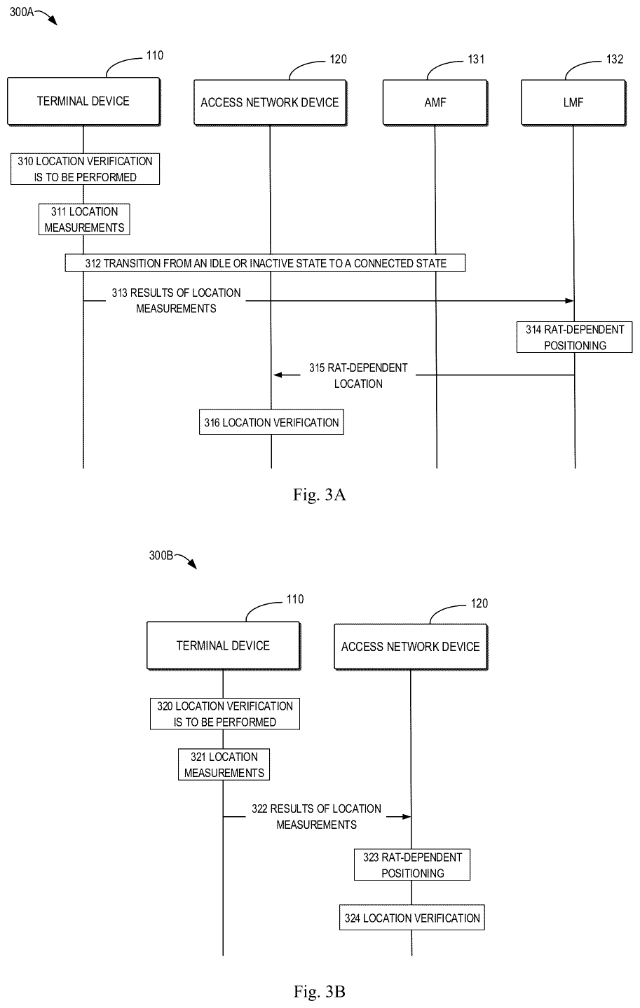

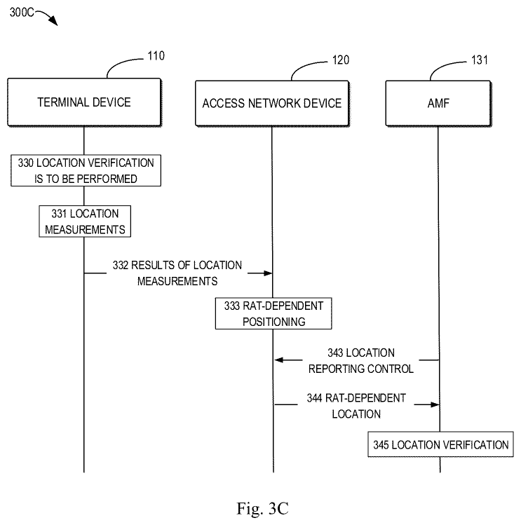

In this embodiment, the terminal device 110 in an idle or inactive state initiates the location verification and the access network device 120 performs the location verification with the LMF 132. This embodiment will be described in connection with FIG. 3A.

FIG. 3A illustrates a schematic diagram illustrating an example process 300A of location verification according to some embodiments of the present disclosure. For the purpose of discussion, the process 300A will be described with reference to FIG. 1. The process 300A may involve the terminal device 110, the access network device 120, the AMF 131 and LMF 132 as illustrated in FIG. 1. It is to be understood that an order of steps in the process 300A is merely for example and the present disclosure does not make limitation on the order.

As shown in FIG. 3A, the terminal device 110 may determine 310 that a location verification is to be performed as described above. Then the terminal device 110 may perform 311 location measurements for a RAT-dependent positioning procedure. For example, the terminal device 110 may perform the location measurements based on LTE positioning protocol (LPP) assistant data configured during previous connection.

The terminal device 110 may transition 312 from the idle or inactive state to a connected state. Then the terminal device 110 may transmit 313 results of the location measurements to the LMF 132. In some embodiments, the terminal device 110 may also transmit an indication that the results are to be used for the location verification. For example, the terminal device 110 may provide unsolicited location information to the LMF 132 via a ProvideLocationInformation message, and indicate that the location information is for location verification. It is to be understood that any other suitable ways are also feasible. Accordingly, the LMF 132 may perform 314 a RAT-dependent positioning based on the results to determine a RAT-dependent location of the terminal device 110.

The access network device 120 may acquire 315 the RAT-dependent location from the LMF 132. In some embodiments where the terminal device 110 transmits, to the LMF 132, the indication that the results are to be used for the location verification, the LMF 132 may forward the RAT-dependent location to the access network device 120. In some embodiments, the access network device 120 may transmit a request for obtaining the RAT-dependent location to the LMF 132 and the LMF 132 may transmit the RAT-dependent location to the access network device 120 as a response to the request.

Based on the RAT-dependent location, the access network device 120 may verify 316 a RAT-independent location reported by the terminal device 110. In some embodiments, if a deviation between the RAT-independent location and the RAT-dependent location is smaller than or equal to a threshold deviation, the access network device 120 may determine that the verifying is successful and the location of the terminal device 110 is trustable. In some embodiments, if a deviation between the RAT-independent location and the RAT-dependent location is greater than or a threshold deviation, the access network device 120 may determine that the verifying is unsuccessful and the location of the terminal device 110 is un-trustable. It is to be understood that any other suitable verifying ways are also feasible.

### EMBODIMENT 2

In this embodiment, the terminal device 110 in an idle or inactive state initiates the location verification and the access network device 120 performs the location verification without LMF. This embodiment will be described in connection with FIG. 3B.

FIG. 3B illustrates a schematic diagram illustrating an example process 300B of location verification according to some embodiments of the present disclosure. For the purpose of discussion, the process 300B will be described with reference to FIG. 1. The process 300B may involve the terminal device 110 and the access network device 120 as illustrated in FIG. 1. It is to be understood that an order of steps in the process 300B is merely for example and the present disclosure does not make limitation on the order.

As shown in FIG. 3B, the terminal device 110 may determine 320 that a location verification is to be performed as described above. Then the terminal device 110 may perform 321 location measurements for a RAT-dependent positioning procedure.

The terminal device 110 may transmit 322 results of the location measurements to the access network device 120. In some embodiments, the terminal device 110 may transmit the results in small data transmission under an idle or inactive state. In some embodiments, the terminal device 110 may enter a connected state to transmit the results. In some embodiments, the terminal device 110 may also transmit an indication that the results are to be used for the location verification.

The access network device 120 may perform 323 a RAT-dependent positioning based on the results to determine a RAT-dependent location of the terminal device 110. Based on the RAT-dependent location, the access network device 120 may verify 324 a RAT-independent location reported by the terminal device 110.

Other details may be similar to that described in Embodiment 1 and thus is not repeated here for concise.

### EMBODIMENT 3

In this embodiment, the terminal device 110 in an idle or inactive state initiates the location verification and the AMF 131 performs the location verification without LMF. This embodiment will be described in connection with FIG. 3C.

FIG. 3C illustrates a schematic diagram illustrating an example process 300C of location verification according to some embodiments of the present disclosure. For the purpose of discussion, the process 300C will be described with reference to FIG. 1. The process 300C may involve the terminal device 110, the access network device 120 and the AMF 131 as illustrated in FIG. 1. It is to be understood that an order of steps in the process 300C is merely for example and the present disclosure does not make limitation on the order.

As shown in FIG. 3C, the terminal device 110 may determine 330 that a location verification is to be performed as described above. Then the terminal device 110 may perform 331 location measurements for a RAT-dependent positioning procedure.

The terminal device 110 may transmit 332 results of the location measurements to the access network device 120. In some embodiments, the terminal device 110 may transmit the results in small data transmission under an idle or inactive state. In some embodiments, the terminal device 110 may enter a connected state to transmit the results. In some embodiments, the terminal device 110 may also transmit an indication that the results are to be used for the location verification.

The access network device 120 may perform 333 a RAT-dependent positioning based on the results to determine a RAT-dependent location of the terminal device 110.

The AMF 131 may perform 343 location reporting control to the access network device 120 for verification validity maintenance. In some embodiments, a Location Reporting Request Type IE may be used to indicate to the access network device 120 to perform location verification of the terminal device 110 or perform location verification when the location verification of the terminal device 110 expires.

The access network device 120 may transmit 344, to the AMF 131, a location report comprising the RAT-dependent location, e.g., when location verification of the terminal device 110 expires.

Based on the RAT-dependent location, the AMF 131 may verify 345 a RAT-independent location reported by the terminal device 110. In some embodiments, if a deviation between the RAT-independent location and the RAT-dependent location is smaller than or equal to a threshold deviation, the AMF 131 may determine that the verifying is successful and the location of the terminal device 110 is trustable. In some embodiments, if a deviation between the RAT-independent location and the RAT-dependent location is greater than or equal to a threshold deviation, the AMF 131 may determine that the verifying is unsuccessful and the location of the terminal device 110 is un-trustable. It is to be understood that any other suitable verifying ways are also feasible.

Other details may be similar to that described in Embodiment 1 and thus is not repeated here for concise.

In some embodiments, a network may acquire both a RAT-dependent location and a RAT-independent location of a terminal device and use the RAT-dependent location to verify the RAT-dependent location. If the verifying is successful, a location of a terminal device will be considered as trustable for a period of time. In this case, both a RAT-dependent positioning and a RAT-independent location delivery may be initiated. For illustration, some example embodiments will be described in connection with Embodiments 4 to 10.

### EMBODIMENT 4

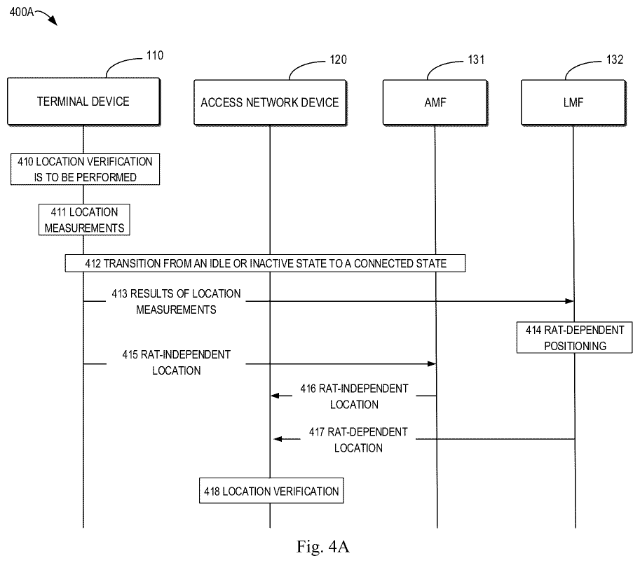

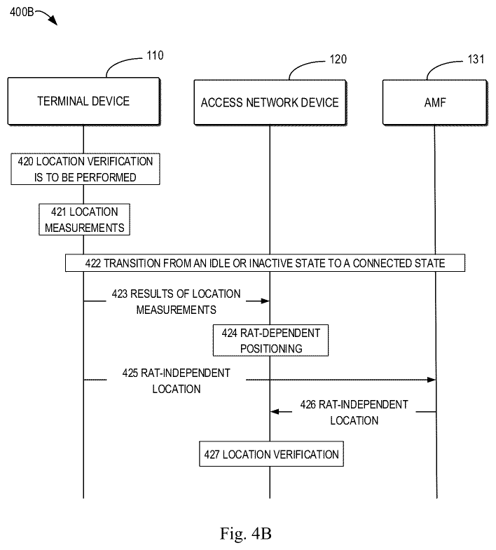

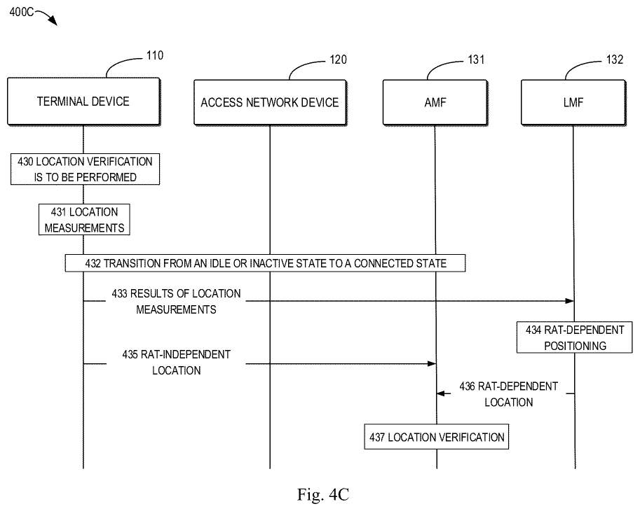

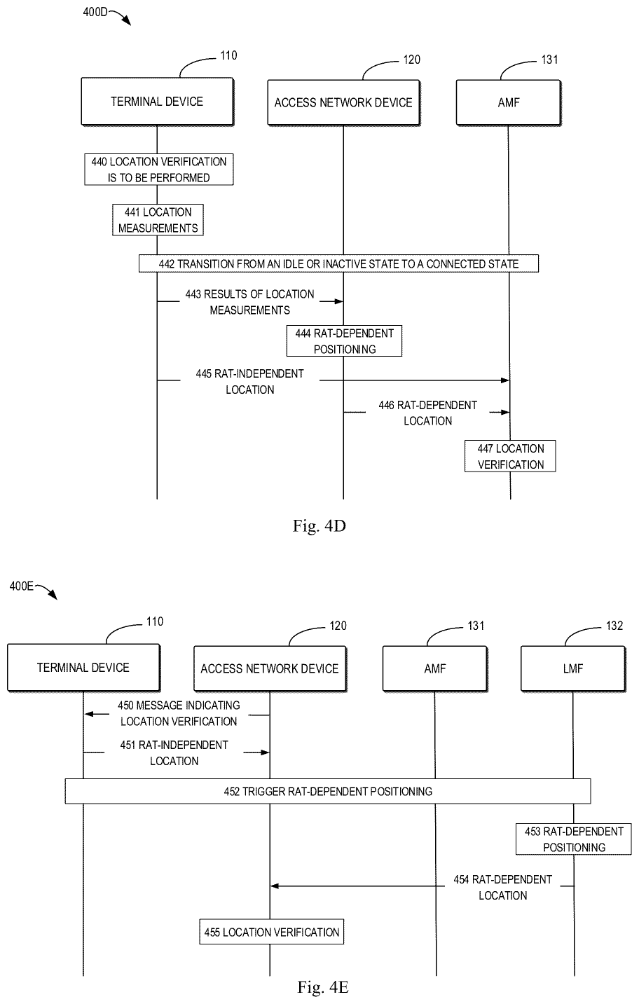

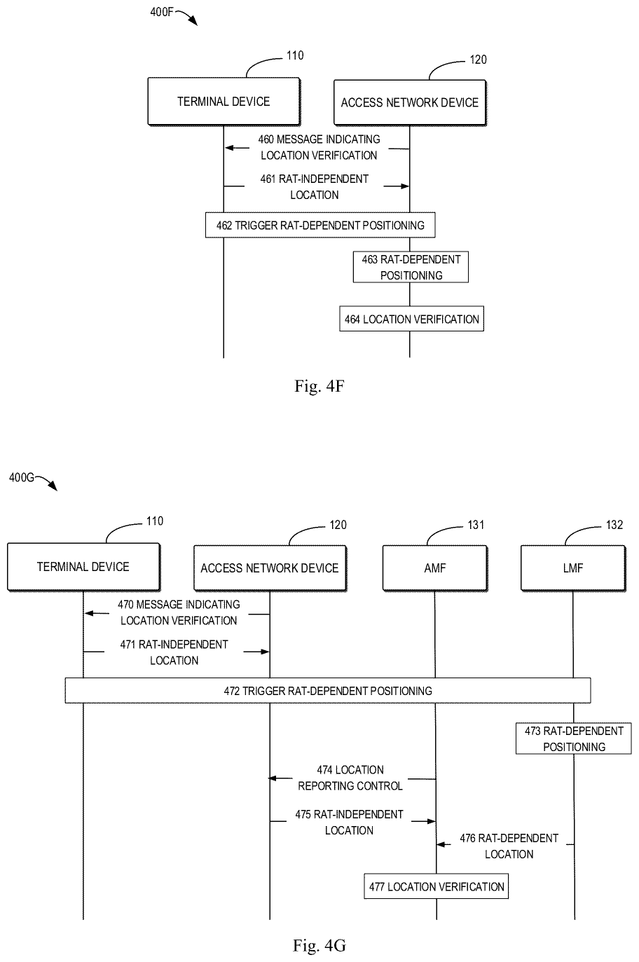

In this embodiment, the terminal device 110 in an idle or inactive state initiates the location verification and the access network device 120 performs the location verification with the LMF 132. This embodiment will be described in connection with FIG. 4A.

FIG. 4A illustrates a schematic diagram illustrating an example process 400A of location verification according to some embodiments of the present disclosure. For the purpose of discussion, the process 400A will be described with reference to FIG. 1. The process 400A may involve the terminal device 110, the access network device 120, the AMF 131 and LMF 132 as illustrated in FIG. 1. It is to be understood that an order of steps in the process 400A is merely for example and the present disclosure does not make limitation on the order.

As shown in FIG. 4A, the terminal device 110 may determine 410 that a location verification is to be performed as described above. Then the terminal device 110 may perform 411 location measurements for a RAT-dependent positioning procedure.

The terminal device 110 may transition 412 from the idle or inactive state to a connected state. Then the terminal device 110 may transmit 413 results of the location measurements to the LMF 132. In some embodiments, the terminal device 110 may also transmit an indication that the results are to be used for the location verification. The LMF 132 may perform 414 a RAT-dependent positioning based on the results to determine a RAT-dependent location of the terminal device 110.

The terminal device 110 may also trigger 415 RAT-independent location delivery via a non-access stratum (NAS) message after successful NAS security activation. In some embodiments, the terminal device 110 may report a RAT-independent location to the AMF 131 via an uplink (UL) NAS transport message, and the AMF 131 may forward the RAT-independent location to the access network device 120 via a UE information transfer message. In some embodiments, the terminal device 110 may directly deliver the RAT-independent location to the access network device 120. In some embodiments, the terminal device 110 may deliver the RAT-independent location via small data transmission under an idle or inactive state. In some embodiments, the terminal device 110 may enter a connected state to deliver the RAT-independent location.

In some embodiments, the terminal device 110 may further transmit, to the AMF 131, an indication indicating association between the RAT-dependent positioning procedure and the RAT-independent location. In other words, the terminal device 110 may associate the RAT-independent location with the RAT-dependent positioning procedure. For example, the terminal device 110 may indicate a transaction ID of the RAT-dependent positioning procedure in a GNSS location report. It is to be understood that the terminal device 110 may transmit any other suitable information to indicate the association between the RAT-dependent positioning procedure and the RAT-independent location.

The access network device 120 may acquire 417 the RAT-dependent location from the LMF 132. Based on the RAT-dependent location and the RAT-independent location, the access network device 120 may perform 418 the location verification. Other details may be similar to that described in Embodiment 1 and is not repeated here for concise.

### EMBODIMENT 5

In this embodiment, the terminal device 110 in an idle or inactive state initiates the location verification and the access network device 120 performs the location verification without LMF. This embodiment will be described in connection with FIG. 4B.

FIG. 4B illustrates a schematic diagram illustrating an example process 400B of location verification according to some embodiments of the present disclosure. For the purpose of discussion, the process 400B will be described with reference to FIG. 1. The process 400B may involve the terminal device 110, the access network device 120 and the AMF 131 as illustrated in FIG. 1. It is to be understood that an order of steps in the process 400B is merely for example and the present disclosure does not make limitation on the order.

As shown in FIG. 4B, the terminal device 110 may determine 420 that a location verification is to be performed as described above. Then the terminal device 110 may perform 421 location measurements for a RAT-dependent positioning procedure.

The terminal device 110 may transition 422 from the idle or inactive state to a connected state. Then the terminal device 110 may transmit 423 results of the location measurements to the access network device 120. In some embodiments, the terminal device 110 may also transmit an indication that the results are to be used for the location verification. The access network device 120 may perform 424 a RAT-dependent positioning based on the results to determine a RAT-dependent location of the terminal device 110.

The terminal device 110 may also trigger 425 RAT-independent location delivery via a NAS message after successful NAS security activation. In some embodiments, the terminal device 110 may report a RAT-independent location to the AMF 131 via an UL NAS transport message, and the AMF 131 may forward 416 the RAT-independent location to the access network device 120 via a UE information transfer message. In some embodiments, the terminal device 110 may directly deliver the RAT-independent location to the access network device 120. In some embodiments, the terminal device 110 may deliver the RAT-independent location via small data transmission under an idle or inactive state. In some embodiments, the terminal device 110 may enter a connected state to deliver the RAT-independent location.

In some embodiments, the terminal device 110 may further transmit, to the AMF 131, an indication indicating association between the RAT-dependent positioning procedure and the RAT-independent location. In other words, the terminal device 110 may associate the RAT-independent location with the RAT-dependent positioning procedure. For example, the terminal device 110 may indicate a transaction ID in a GNSS location report. It is to be understood that the terminal device 110 may transmit any other suitable information to indicate the association between the RAT-dependent positioning procedure and the RAT-independent location.

The AMF 131 may forward 426 the RAT-independent location to the access network device 120 via a UE information transfer message. Based on the RAT-dependent location and the RAT-independent location, the access network device 120 may perform 427 the location verification. Other details may be similar to that described in Embodiment 1 and is not repeated here for concise.

### EMBODIMENT 6

In this embodiment, the terminal device 110 in an idle or inactive state initiates the location verification and the AMF 131 performs the location verification with the LMF 132. This embodiment will be described in connection with FIG. 4C.

FIG. 4C illustrates a schematic diagram illustrating an example process 400C of location verification according to some embodiments of the present disclosure. For the purpose of discussion, the process 400C will be described with reference to FIG. 1. The process 400C may involve the terminal device 110, the access network device 120, the AMF 131 and the LMF 132 as illustrated in FIG. 1. It is to be understood that an order of steps in the process 400C is merely for example and the present disclosure does not make limitation on the order.

As shown in FIG. 4C, the terminal device 110 may determine 430 that a location verification is to be performed as described above. Then the terminal device 110 may perform 431 location measurements for a RAT-dependent positioning procedure.

The terminal device 110 may transition 432 from the idle or inactive state to a connected state. Then the terminal device 110 may transmit 433 results of the location measurements to the LMF 132. In some embodiments, the terminal device 110 may also transmit an indication that the results are to be used for the location verification. The LMF 132 may perform 434 a RAT-dependent positioning based on the results to determine a RAT-dependent location of the terminal device 110.

The terminal device 110 may also trigger 435 RAT-independent location delivery via a NAS message after successful NAS security activation. In some embodiments, the terminal device 110 may report a RAT-independent location to the AMF 131 via an UL NAS transport message, and the AMF 131 may forward 416 the RAT-independent location to the access network device 120 via a UE information transfer message. In some embodiments, the terminal device 110 may directly deliver the RAT-independent location to the access network device 120. In some embodiments, the terminal device 110 may deliver the RAT-independent location via small data transmission under an idle or inactive state. In some embodiments, the terminal device 110 may enter a connected state to deliver the RAT-independent location.

In some embodiments, the terminal device 110 may further transmit, to the AMF 131, an indication indicating association between the RAT-dependent positioning procedure and the RAT-independent location. In other words, the terminal device 110 may associate the RAT-independent location with the RAT-dependent positioning procedure. For example, the terminal device 110 may indicate a transaction ID in a GNSS location report. It is to be understood that the terminal device 110 may transmit any other suitable information to indicate the association between the RAT-dependent positioning procedure and the RAT-independent location.

The AMF 131 may acquire 436 the RAT-dependent location from the LMF 132. Based on the RAT-dependent location and the RAT-independent location, the AMF 131 may perform 437 the location verification. In some embodiments, if a deviation between the RAT-independent location and the RAT-dependent location is smaller than or equal to a threshold deviation, the AMF 131 may determine that the verifying is successful and the location of the terminal device 110 is trustable. In some embodiments, if a deviation between the RAT-independent location and the RAT-dependent location is greater than or a threshold deviation, the AMF 131 may determine that the verifying is unsuccessful and the location of the terminal device 110 is un-trustable. It is to be understood that any other suitable verifying ways are also feasible.

Other details may be similar to that described in Embodiment 1 and is not repeated here for concise.

### EMBODIMENT 7

In this embodiment, the terminal device 110 in an idle or inactive state initiates the location verification and the AMF 131 performs the location verification without LMF. This embodiment will be described in connection with FIG. 4D.

FIG. 4D illustrates a schematic diagram illustrating an example process 400D of location verification according to some embodiments of the present disclosure. For the purpose of discussion, the process 400D will be described with reference to FIG. 1. The process 400D may involve the terminal device 110, the access network device 120 and the AMF 131 as illustrated in FIG. 1. It is to be understood that an order of steps in the process 400D is merely for example and the present disclosure does not make limitation on the order.

As shown in FIG. 4D, the terminal device 110 may determine 440 that a location verification is to be performed as described above. Then the terminal device 110 may perform 441 location measurements for a RAT-dependent positioning procedure.

The terminal device 110 may transition 442 from the idle or inactive state to a connected state. Then the terminal device 110 may transmit 443 results of the location measurements to the access network device 120. In some embodiments, the terminal device 110 may also transmit an indication that the results are to be used for the location verification. The access network device 120 may perform 444 a RAT-dependent positioning based on the results to determine a RAT-dependent location of the terminal device 110.

The terminal device 110 may also trigger 445 RAT-independent location delivery via a NAS message after successful NAS security activation. In some embodiments, the terminal device 110 may report a RAT-independent location to the AMF 131 via an UL NAS transport message.

In some embodiments, the terminal device 110 may further transmit, to the AMF 131, an indication indicating association between the RAT-dependent positioning procedure and the RAT-independent location. In other words, the terminal device 110 may associate the RAT-independent location with the RAT-dependent positioning procedure. For example, the terminal device 110 may indicate a transaction ID in a GNSS location report. It is to be understood that the terminal device 110 may transmit any other suitable information to indicate the association between the RAT-dependent positioning procedure and the RAT-independent location.

The AMF 131 may acquire 446 the RAT-dependent location from the access network device 120. Based on the RAT-dependent location and the RAT-independent location, the AMF 131 may perform 447 the location verification. In some embodiments, if a deviation between the RAT-independent location and the RAT-dependent location is smaller than or equal to a threshold deviation, the AMF 131 may determine that the verifying is successful and the location of the terminal device 110 is trustable. In some embodiments, if a deviation between the RAT-independent location and the RAT-dependent location is greater than or a threshold deviation, the AMF 131 may determine that the verifying is unsuccessful and the location of the terminal device 110 is un-trustable. It is to be understood that any other suitable verifying ways are also feasible.

Other details may be similar to that described in Embodiment 1 and is not repeated here for concise.

### EMBODIMENT 8

In this embodiment, the terminal device is in a connected state, the access network device 120 initiates the location verification and performs the location verification with the LMF 132. This embodiment will be described in connection with FIG. 4E.

FIG. 4E illustrates a schematic diagram illustrating an example process 400E of location verification according to some embodiments of the present disclosure. For the purpose of discussion, the process 400E will be described with reference to FIG. 1. The process 400E may involve the terminal device 110, the access network device 120, the AMF 131 and LMF 132 as illustrated in FIG. 1. It is to be understood that an order of steps in the process 400E is merely for example and the present disclosure does not make limitation on the order.

As shown in FIG. 4E, the access network device 120 may transmit 450 a message indicating location verification to the terminal device 110. In some embodiments, the access network device 120 may transmit a location verifying request to the terminal device 110. In some embodiments, the access network device 120 may cause an indication of verifying a location of the terminal device 110 to be comprised in a coarseLocationRequest IE of a UE information request message. In some embodiments, the access network device 120 may cause the location verifying request to be comprised in the UE information request message.

The terminal device 110 may forward 451 a RAT-independent location to the access network device 120. In some embodiments, the terminal device 110 may transmit the RAT-independent location in a UE information response message.

The terminal device 110 may also trigger 452 a RAT-dependent positioning. In some embodiments, a RRC layer of the terminal device 110 may indicate a higher layer to initiate a RAT-dependent positioning procedure.

In some embodiments, the terminal device 110 may perform location measurements for the RAT-dependent positioning and transmit results of the location measurements to the LMF 132. In some embodiments, the terminal device 110 may also transmit an indication that the results are to be used for the location verification. The LMF 132 may perform 453 the RAT-dependent positioning based on the results to determine a RAT-dependent location of the terminal device 110.

In some embodiments, the terminal device 110 may further transmit, to the LMF 132, an indication indicating association between the RAT-dependent positioning procedure and the RAT-independent location. In other words, the terminal device 110 may associate the RAT-independent location with the RAT-dependent positioning procedure. For example, the terminal device 110 may indicate a transaction ID in a GNSS location report. It is to be understood that the terminal device 110 may transmit any other suitable information to indicate the association between the RAT-dependent positioning procedure and the RAT-independent location.

The access network device 120 may acquire 454 the RAT-dependent location from the LMF 132. Based on the RAT-dependent location and the RAT-independent location, the access network device 120 may perform 455 the location verification. Other details may be similar to that described in Embodiment 1 and is not repeated here for concise.

### EMBODIMENT 9

In this embodiment, the terminal device is in a connected state, the access network device 120 initiates the location verification and performs the location verification without LMF. This embodiment will be described in connection with FIG. 4F.

FIG. 4F illustrates a schematic diagram illustrating an example process 400F of location verification according to some embodiments of the present disclosure. For the purpose of discussion, the process 400F will be described with reference to FIG. 1. The process 400F may involve the terminal device 110 and the access network device 120 as illustrated in FIG. 1. It is to be understood that an order of steps in the process 400F is merely for example and the present disclosure does not make limitation on the order.

As shown in FIG. 4F, the access network device 120 may transmit 460 a message indicating location verification to the terminal device 110. In some embodiments, the access network device 120 may transmit a location verifying request to the terminal device 110. In some embodiments, the access network device 120 may cause an indication of verifying a location of the terminal device 110 to be comprised in a coarseLocationRequest IE of a UE information request message. In some embodiments, the access network device 120 may cause the location verifying request to be comprised in the UE information request message.

The terminal device 110 may forward 461 a RAT-independent location to the access network device 120. In some embodiments, the terminal device 110 may transmit the RAT-independent location in a UE information response message.

The terminal device 110 may also trigger 462 a RAT-dependent positioning. In some embodiments, the terminal device 110 may perform location measurements for the RAT-dependent positioning and transmit results of the location measurements to the access network device 120. In some embodiments, the terminal device 110 may also transmit an indication that the results are to be used for the location verification. The access network device 120 may perform 463 the RAT-dependent positioning based on the results to determine a RAT-dependent location of the terminal device 110.

In some embodiments, the terminal device 110 may further transmit, to the access network device 120, an indication indicating association between the RAT-dependent positioning procedure and the RAT-independent location. In other words, the terminal device 110 may associate the RAT-independent location with the RAT-dependent positioning procedure. For example, the terminal device 110 may indicate a transaction ID in a GNSS location report. It is to be understood that the terminal device 110 may transmit any other suitable information to indicate the association between the RAT-dependent positioning procedure and the RAT-independent location.

Based on the RAT-dependent location and the RAT-independent location, the access network device 120 may perform 464 the location verification. Other details may be similar to that described in Embodiment 1 and is not repeated here for concise.

### EMBODIMENT 10

In this embodiment, the terminal device is in a connected state, the access network device 120 initiates the location verification, and the AMF 131 performs the location verification with the LMF 132. This embodiment will be described in connection with FIG. 4G.

FIG. 4G illustrates a schematic diagram illustrating an example process 400G of location verification according to some embodiments of the present disclosure. For the purpose of discussion, the process 400G will be described with reference to FIG. 1. The process 400G may involve the terminal device 110, the access network device 120, the AMF 131 and the LMF 132 as illustrated in FIG. 1. It is to be understood that an order of steps in the process 400G is merely for example and the present disclosure does not make limitation on the order.

As shown in FIG. 4G, the access network device 120 may transmit 470 a message indicating location verification to the terminal device 110. In some embodiments, the access network device 120 may transmit a location verifying request to the terminal device 110. In some embodiments, the access network device 120 may cause an indication of verifying a location of the terminal device 110 to be comprised in a coarseLocationRequest IE of a UE information request message. In some embodiments, the access network device 120 may cause the location verifying request to be comprised in the UE information request message.

The terminal device 110 may forward 471 a RAT-independent location to the access network device 120. In some embodiments, the terminal device 110 may transmit the RAT-independent location in a UE information response message.

The terminal device 110 may also trigger 472 a RAT-dependent positioning. In some embodiments, a RRC layer of the terminal device 110 may indicate a higher layer to initiate a RAT-dependent positioning procedure.

In some embodiments, the terminal device 110 may perform location measurements for the RAT-dependent positioning and transmit results of the location measurements to the LMF 132. In some embodiments, the terminal device 110 may also transmit an indication that the results are to be used for the location verification. The LMF 132 may perform 473 the RAT-dependent positioning based on the results to determine a RAT-dependent location of the terminal device 110.

In some embodiments, the terminal device 110 may further transmit, to the LMF 132, an indication indicating association between the RAT-dependent positioning procedure and the RAT-independent location. In other words, the terminal device 110 may associate the RAT-independent location with the RAT-dependent positioning procedure. For example, the terminal device 110 may indicate a transaction ID in a GNSS location report. It is to be understood that the terminal device 110 may transmit any other suitable information to indicate the association between the RAT-dependent positioning procedure and the RAT-independent location.

The AMF 131 may perform 474 location reporting control to the access network device 120 for verification validity maintenance. In some embodiments, a Location Reporting Request Type IE may be used to indicate to the access network device 120 to perform location verification of the terminal device 110 or perform location verification when the location verification of the terminal device 110 expires.

The access network device 120 may transmit 475, to the AMF 131, a location report comprising the RAT-independent location, e.g., when location verification of the terminal device 110 expires. The AMF 131 may acquire 476 the RAT-dependent location from the LMF 132.

Based on the RAT-dependent location and the RAT-independent location, the AMF 131 may perform 477 the location verification. In some embodiments, if a deviation between the RAT-independent location and the RAT-dependent location is smaller than or equal to a threshold deviation, the AMF 131 may determine that the verifying is successful and the location of the terminal device 110 is trustable. In some embodiments, if a deviation between the RAT-independent location and the RAT-dependent location is greater than or a threshold deviation, the AMF 131 may determine that the verifying is unsuccessful and the location of the terminal device 110 is un-trustable. It is to be understood that any other suitable verifying ways are also feasible.

Other details may be similar to that described in Embodiment 1 and thus is not repeated here for concise. So far, the location verification procedure is described.

Continue to refer to FIG. 2, in some embodiments, if unsuccessful information of the location verification is received or the location verification is invalid, the terminal device 110 may start 230 a second timer. In these embodiments, the access network device 120 may also start 230′ the second timer.

During the second timer is running, the terminal device 110 may initiate 240 the re-verifying procedure. In some embodiments, upon start of the second timer, the terminal device 110 may increment a value of a counter. If the value the counter is smaller than or equal to a predetermined value, the terminal device 110 may initiate the re-verifying procedure. In some embodiments, the predetermined value is the configured maximum times of initiating the re-verifying procedure.

In some embodiments, if the re-verifying procedure is successful, the access network device 120 may transmit 250 successful information of the re-verifying procedure to the terminal device 110. The terminal device 110 may stop 260 the second timer.

In some embodiments, if the second timer expires, the access network device 120 may perform 270 a NAS deregistration procedure. In some embodiments, the access network device 120 may transmit, to the AMF 131 (not shown), a UE context release request message with a cause value indicating unsuccessful location verification (e.g., UE is not in a public land mobile network (PLMN) serving area, UE location verify failed, or UE location untrusted). The AMF 131 may initiate a NAS deregistration procedure. Accordingly, the terminal device 110 may perform an operation associated with the NAS deregistration procedure.

### EXAMPLE IMPLEMENTATION OF INITIAL VERIFICATION

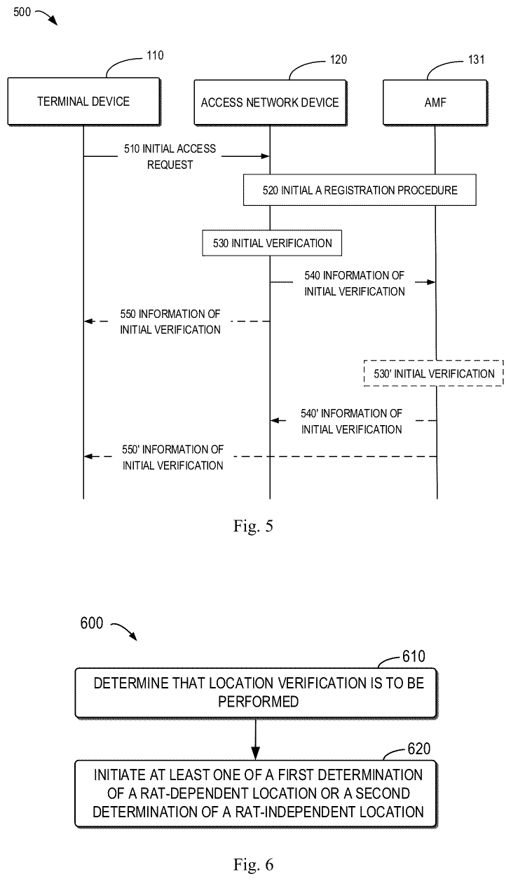

FIG. 5 illustrates a schematic diagram illustrating a process 500 for initial verification according to embodiments of the present disclosure. For the purpose of discussion, the process 500 will be described with reference to FIG. 1. The process 500 may involve the terminal device 110, the access network device 120 and the AMF 131 as illustrated in FIG. 1. It is to be understood that an order of steps in the process 500 is merely for example and the present disclosure does not make limitation on the order.

As shown in FIG. 5, when the terminal device 110 initially access a network, the terminal device 110 may transmit 510 an initial access request to the access network device 120. The initial access request may comprise a location (also referred to as an initial location herein) of the terminal device 110.

In some embodiments, the initial access request may comprise geographic area information, for example, geographic area ID or any other suitable information. In some embodiments, the initial location may comprise a virtual cell or timing advance (TA). In some embodiments, the initial location may comprise a GNSS location (e.g., a coarse GNSS location). In this way, the initial location of the terminal device 110 may be indicated to a network.

The access network device 120 may initiate 520, to the AMF 131, a registration procedure with the initial location marked as un-verified. In some embodiments, the terminal device 110 that has not performed location verification is marked as not trustable. In some embodiments, the access network device 120 may perform 530 an initial verification, i.e., verify the initial location. In some embodiments, the access network device 120 may perform 530 an initial verification in a predefined time period. The access network device 120 may transmit 540 successful or unsuccessful information of the initial verification to the AMF 131. In some embodiments, the access network device 120 may transmit 550 the successful or unsuccessful information of the initial verification the terminal device 110.

In some alternative embodiments, the AMF 131 may perform 530′ the initial verification. The AMF 131 may transmit 540′ successful or unsuccessful information of the initial verification to at least one of the access network device 120 or the terminal device 110.

So far, verification of a UE location may be carried out by a network. It is to be understood that the above embodiments described in connection with FIGS. 2 to 5 may be carried out separately or in any suitable combination.

### EXAMPLE IMPLEMENTATION OF METHODS

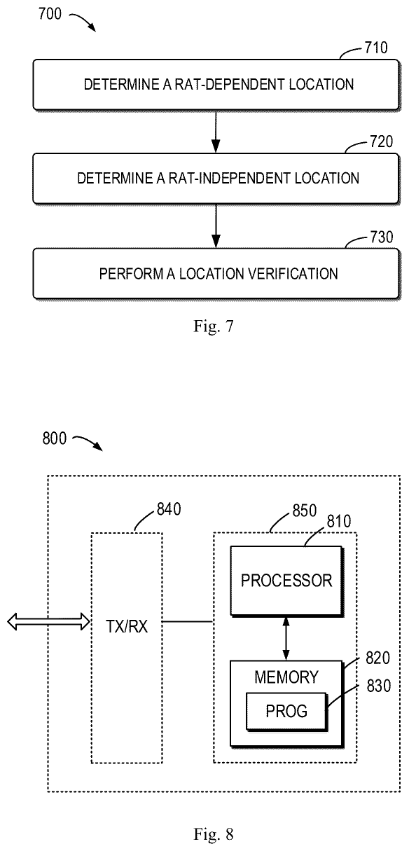

Accordingly, embodiments of the present disclosure provide methods of communication implemented at a terminal device and a network device. These methods will be described below with reference to FIGS. 6 to 7.

FIG. 6 illustrates an example method 600 of communication implemented at a terminal device in accordance with some embodiments of the present disclosure. For example, the method 600 may be performed at the terminal device 110 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

At block 610, the terminal device 110 may determine that a location verification for the terminal device 110 is to be performed. In some embodiments, the determining may be based on at least one of the following: a first timer configured for validity of the location verification expires; a variation of a location of the terminal device exceeds a threshold variation; or a message indicating the location verification is received.

In some embodiments, if a moving distance exceeds a threshold distance, the terminal device 110 may determine that the variation of the location of the terminal device 110 exceeds the threshold variation. In some embodiments, if a variation of at least one of longitude, latitude or altitude exceeds a predetermined variation, the terminal device 110 may determine that the variation of the location of the terminal device 110 exceeds the threshold variation. In some embodiments, if the terminal device 110 enters a predefined area, the terminal device 110 may determine that the variation of the location of the terminal device 110 exceeds the threshold variation.

In some embodiments, if successful information of the location verification or a RRC release message is received, the terminal device 110 may start or restart the first timer. If the first timer expires, the terminal device 110 may determine that the location verification is invalid.

In some embodiments, if a RAT-independent location is to be reported, the terminal device 110 may determine whether the location verification is valid. In some embodiments, if the location verification is invalid, the terminal device 110 may determine that a location verification for the terminal device is to be performed.

At block 620, the terminal device 110 may initiate at least one of a first determination of a RAT-dependent location or a second determination of a RAT-independent location. In some embodiments, the terminal device 110 may initiate the first determination by performing location measurements for a RAT-dependent positioning procedure, and transmitting results of the location measurements. In some embodiments, the terminal device 110 may further transmit an indication that the results are to be used for the location verification.

In some embodiments, the terminal device 110 may initiate the second determination by transmitting a RAT-independent location for the location verification. In some embodiments, the terminal device 110 may further transmit an indication indicating association between the RAT-dependent positioning procedure and the RAT-independent location.

In some embodiments, the terminal device 110 may receive information of the location verification. In some embodiments, the terminal device 110 may receive unsuccessful or successful information of the location verification. In some embodiments, the terminal device 110 may receive only unsuccessful information of the location verification. In some embodiments, the terminal device 110 may receive an indication of remaining time in which the location verification is valid.

In some embodiments, if unsuccessful information of the location verification is received or the location verification is invalid, the terminal device 110 may start a second timer. If the second timer is running, the terminal device 110 may initiate a re-verifying procedure. In some embodiments, upon start of the second timer, the terminal device 110 may increment a value of a counter. If the value the counter is smaller than or equal to a predetermined value, the terminal device 110 may initiate the re-verifying procedure.

In some embodiments, if successful information of the re-verifying procedure is received, the terminal device 110 may stop the second timer. If the second timer expires, the terminal device 110 may perform an operation associated with a NAS deregistration procedure.

With the method 600, location information reported by a terminal device may be ensured to be verified by a network.

FIG. 7 illustrates an example method 700 of communication implemented at a network device in accordance with some embodiments of the present disclosure. For example, the method 700 may be performed at the access network device 120 or the AMF 131 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, a network device (e.g., the access network device 120 or the AMF 131) determines a RAT-dependent location for the terminal device 110.

At block 720, the network device determines a RAT-independent location for the terminal device 110.

At block 730, the network device performs a location verification for the terminal device 110 based on the RAT-dependent location and the RAT-independent location.

In some embodiments, the network device may transmit a message indicating the location verification.

In some embodiments, the network device may determine the RAT-independent location by receiving the RAT-independent location.

In some embodiments where the network device is the access network device 120, the network device may determine the RAT-dependent location by receiving results of location measurements, and performing, based on the results, a RAT-dependent positioning procedure for determination of the RAT-dependent location. In some embodiments, the network device may further receive an indication that the results are to be used for the location verification.

In some embodiments, the network device may receive an indication indicating association between the RAT-dependent positioning procedure and the RAT-independent location. In some embodiments, the network device may determine the RAT-dependent location by transmitting, based on the association, a request for obtaining the RAT-dependent location; and receiving the RAT-dependent location.

In some embodiments, the network device may perform a registration procedure with an initial location marked as un-verified, the initial location being comprised in an initial access request from the terminal device 110.

In some embodiments, the network device may transmit information of the location verification. In some embodiments, the network device may transmit unsuccessful or successful information of the location verification. In some embodiments, the network device may transmit only unsuccessful information of the location verification. In some embodiments, the network device may transmit an indication of remaining time in which the location verification is valid.

In some embodiments, if successful information of the location verification is transmitted, the network device may start or restart a first timer. If the first timer expires, the network device may transmit an indication indicating that a further location verification is to be initiated by the terminal device 110.

In some embodiments, if unsuccessful information of the location verification is transmitted or the location verification is invalid, the network device may start a second timer. If a re-verifying procedure is successful, the network device may transmit successful information of the re-verifying procedure. If the second timer expires, the network device may perform a NAS deregistration procedure.

In some embodiments, the network device may transmit a configuration for maximum times of initiating the re-verifying procedure.

In some embodiments, the network device may be an access network device. In some embodiments, the network device may be a core network device.

With the method 700, location information reported by a terminal device may be verified by a network.

### EXAMPLE IMPLEMENTATION OF DEVICE AND APPARATUS

FIG. 8 is a simplified block diagram of a device 800 that is suitable for implementing embodiments of the present disclosure. The device 800 can be considered as a further example implementation of the terminal device 110 or the access network device 120 as shown in FIG. 1. Accordingly, the device 800 can be implemented at or as at least a part of the terminal device 110, the access network device 120 or the AMF 131.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 2 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a terminal device comprises a circuitry configured to: determine that a location verification for the terminal device is to be performed; and initiate at least one of a first determination of a radio access technology-dependent location or a second determination of a radio access technology-independent location.

In some embodiments, a network device comprises a circuitry configured to: determine a radio access technology-dependent location for a terminal device; determine a radio access technology-independent location for the terminal device; and perform a location verification for the terminal device based on the radio access technology-dependent location and the radio access technology-independent location.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: determining, at a terminal device, that a location verification for the terminal device is to be performed; and initiating at least one of a first determination of a radio access technology-dependent location or a second determination of a radio access technology-independent location.

In some embodiments, the determining is based on at least one of the following: a first timer configured for validity of the location verification expires; a variation of a location of the terminal device exceeds a threshold variation; or a message indicating the location verification is received.

In some embodiments, the method above further comprises: determining that the variation of the location of the terminal device exceeds the threshold variation based on at least of the following: a moving distance exceeding a threshold distance; a variation of at least one of longitude, latitude or altitude exceeding a predetermined variation; or the terminal device entering a predefined area.

In some embodiments, initiating the first determination comprises: performing location measurements for a radio access technology-dependent positioning procedure; and transmitting results of the location measurements.

In some embodiments, the method above further comprises: transmitting an indication that the results are to be used for the location verification.

In some embodiments, initiating the second determination comprises: transmitting a radio access technology-independent location for the location verification.

In some embodiments, the method above further comprises: transmitting an indication indicating association between the radio access technology-dependent positioning procedure and the radio access technology-independent location.

In some embodiments, the determining comprises: in accordance with a determination that a radio access technology-independent location is to be reported, determining whether the location verification is valid; and in accordance with a determination that the location verification is invalid, determining that the location verification for the terminal device is to be performed.

In some embodiments, the method further comprises: receiving information of the location verification.

In some embodiments, receiving the information of the location verification comprises at least one of the following: receiving unsuccessful or successful information of the location verification; receiving only unsuccessful information of the location verification; or receiving an indication of remaining time in which the location verification is valid.

In some embodiments, the method above further comprises: in accordance with a determination that successful information of the location verification or a radio resource control release message is received, starting or restarting a first timer; and in accordance with a determination that the first timer expires, determining that the location verification is invalid.

In some embodiments, the method above further comprises: in accordance with a determination that unsuccessful information of the location verification is received or the location verification is invalid, starting a second timer; and in accordance with a determination that the second timer is running, initiating a re-verifying procedure.

In some embodiments, initiating the re-verifying procedure comprises: incrementing a value of a counter; and in accordance with a determination that the value the counter is smaller than or equal to a predetermined value, initiating the re-verifying procedure.

In some embodiments, the method above further comprises: in accordance with a determination that successful information of the re-verifying procedure is received, stopping the second timer; or in accordance with a determination that the second timer expires, performing an operation associated with a non-access stratum deregistration procedure.

In another solution, a method of communication comprises: determining, at a network device, a radio access technology-dependent location for a terminal device; determining a radio access technology-independent location for the terminal device; and performing a location verification for the terminal device based on the radio access technology-dependent location and the radio access technology-independent location.

In some embodiments, the method further comprises: transmitting a message indicating the location verification.

In some embodiments, determining the radio access technology-independent location comprises: receiving the radio access technology-independent location.

In some embodiments where the network device is an access network device, determining the radio access technology-dependent location comprises: receiving results of location measurements; and performing, based on the results, a radio access technology-dependent positioning procedure for determination of the radio access technology-dependent location.

In some embodiments, the method further comprises: receiving an indication that the results are to be used for the location verification.

In some embodiments, the method further comprises: receiving an indication indicating association between the radio access technology-dependent positioning procedure and the radio access technology-independent location.

In some embodiments, determining the radio access technology-dependent location comprises: transmitting, based on the association, a request for obtaining the radio access technology-dependent location; and receiving the radio access technology-dependent location.

In some embodiments, the method further comprises: performing a registration procedure with an initial location marked as un-verified, the initial location being comprised in an initial access request from the terminal device; or transmitting information of the location verification.

In some embodiments, transmitting the information of the location verification comprises at least one of the following: transmitting unsuccessful or successful information of the location verification; transmitting only unsuccessful information of the location verification; or transmitting an indication of remaining time in which the location verification is valid.

In some embodiments, the method further comprises: in accordance with a determination that successful information of the location verification is transmitted, starting or restarting a first timer; and in accordance with a determination that the first timer expires, transmitting an indication indicating that a further location verification is to be initiated by the terminal device.

In some embodiments, the method further comprises at least one of the following: in accordance with a determination that unsuccessful information of the location verification is transmitted or the location verification is invalid, starting a second timer; in accordance with a determination that a re-verifying procedure is successful, transmitting successful information of the re-verifying procedure; or in accordance with a determination that the second timer expires, performing a non-access stratum deregistration procedure.

In some embodiments, the method further comprises: transmitting a configuration for maximum times of initiating the re-verifying procedure.

In some embodiments, the network device is an access network device or a core network device.

In another solution, a device of communication comprises: a processor configured to perform the method according to any of the claims above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21-40. (canceled)

41. A method performed by a mobility management function (AMF), the method comprising:
transmitting, to a location management function (LMF), a request for a first location information of a terminal device, wherein the request comprises a first indication that the request is for location verification; and
receiving, from the LMF, a response including the first location information of the terminal device.

42. The method of claim 41, further comprising verifying the first location information of the terminal device.

43. The method of claim 41, further comprising:
receiving, from a network device, a message including a second location information of the terminal device; and
verifying the second location information of the terminal device.

44. The method of claim 41, wherein the first location information of the terminal device is determined based on a long term evolution positioning protocol (LPP) between the LMF and the terminal device, and
wherein the first location information of the terminal device is determined based on at least one method of:
new radio enhanced cell identity (NR E-CID);
new radio downlink time difference of arrival (NR DL-TDOA);
new radio downlink angle-of-departure (NR DL-AoD); and
new radio multi-round trip time (NR Multi-RTT) positioning.

45. The method of claim 41, further comprising:
transmitting, to the terminal device, a second indication in a case where the first location information of the terminal device indicates that the terminal device is not in a public land mobile network (PLMN) serving area, wherein the second indication is used for the terminal device to start a timer; and
transmitting, to the terminal device, a third indication indicating a time value associated with the timer.

46. The method of claim 45, wherein a determination of performing the location verification is made by the terminal device in a case where a distance between the first location information of the terminal device and a current location of the terminal device is larger than a threshold.

47. A method performed by a location management function (LMF), the method comprising:
receiving, from a mobility management function (AMF), a request for a first location information of a terminal device, wherein the request comprises a first indication that the request is for location verification; and
transmitting, to the AMF, a response including the first location information of the terminal device, wherein the first location information of the terminal device is used for the location verification performed by the AMF.

48. The method of claim 47, wherein the first location information of the terminal device is determined based on a long term evolution positioning protocol (LPP) between the LMF and the terminal device, and
wherein the first location information of the terminal device is determined based on at least one method of:
new radio enhanced cell identity (NR E-CID);
new radio downlink time difference of arrival (NR DL-TDOA);
new radio downlink angle-of-departure (NR DL-AoD); and
new radio multi-round trip time (NR Multi-RTT) positioning.

49. A method performed by a terminal device, the method comprising
receiving, from a mobility management function (AMF), a first indication in a case where a first location information of the terminal device which is acquired from a location management function (LMF) by the AMF indicates that the terminal device is not in a public land mobile network (PLMN) serving area;
receiving, from the AMF, a second indication indicating a time value associated with a timer; and
starting the timer.

50. The method of claim 49, further comprising:
determining the first location information of the terminal device based on a long term evolution positioning protocol (LPP) between the LMF and the terminal device; and
transmitting, to the LMF, the first location information of the terminal device;
wherein the first location information of the terminal device is determined based on at least one method of:
new radio enhanced cell identity (NR E-CID);
new radio downlink time difference of arrival (NR DL-TDOA);
new radio downlink angle-of-departure (NR DL-AoD); and
new radio multi-round trip time (NR Multi-RTT) positioning.

51. The method of claim 49, further comprising determining to perform a location verification in a case where a distance between the first location information of the terminal device and a current location of the terminal device is larger than a threshold.

52. A mobility management function (AMF) comprising a processor configured to cause the AMF to:
transmit, to a location management function (LMF), a request for a first location information of a terminal device, wherein the request comprises a first indication that the request is for location verification; and
receive, from the LMF, a response including the first location information of the terminal device.

53. The AMF of claim 52, wherein the processor is further configured to cause the AMF to verify the first location information of the terminal device.

54. The AMF of claim 52, wherein the processor is further configured to cause the AMF to:
receive, from, a network device, a message including a second location information of the terminal device; and
verify the second location information of the terminal device.

55. The AMF of claim 52, wherein the first location information of the terminal device is determined based on a long term evolution positioning protocol (LPP) between the LMF and the terminal device, and
wherein the first location information of the terminal device is determined based on at least one method of:
new radio enhanced cell identity (NR E-CID);
new radio downlink time difference of arrival (NR DL-TDOA);
new radio downlink angle-of-departure (NR DL-AoD); and
new radio multi-round trip time (NR Multi-RTT) positioning.

56. The AMF of claim 52, wherein the processor is further configured to cause the AMF to:
transmit, to the terminal device, a second indication in a case where the first location information of the terminal device indicates that the terminal device is not in a public land mobile network (PLMN) serving area, wherein the second indication is used for the terminal device to start a timer; and
transmit, to the terminal device, a third indication indicating a time value associated with the timer.

57. The AMF of claim 56, wherein a determination of performing the location verification is made by the terminal device in a case where a distance between the first location information of the terminal device and a current location of the terminal device is larger than a threshold.

58. A location management function (LMF) comprising a processor configured to cause the LMF to:
receive, from a mobility management function (AMF), a request for a first location information of a terminal device, wherein the request comprises a first indication that the request is for location verification; and
transmit, to the AMF, a response including the first location information of the terminal device, wherein the first location information of the terminal device is used for the location verification performed by the AMF.

59. The LMF of claim 58, wherein the first location information of the terminal device is determined based on a long term evolution positioning protocol (LPP) between the LMF and the terminal device, and
wherein the first location information of the terminal device is determined based on at least one method of:
new radio enhanced cell identity (NR E-CID);
new radio downlink time difference of arrival (NR DL-TDOA);
new radio downlink angle-of-departure (NR DL-AoD); and
new radio multi-round trip time (NR Multi-RTT) positioning.

60. A terminal device comprising a processor configured to cause the terminal device to:
receive, from a mobility management function (AMF), a first indication in a case where a first location information of the terminal device which is acquired from a location management function (LMF) by the AMF indicates that the terminal device is not in a public land mobile network (PLMN) serving area;
receive, from the AMF, a second indication indicating a time value associated with a timer; and
start the timer.

61. The terminal device of claim 60, wherein the processor is further configured to cause the terminal device to:
determine the first location information of the terminal device based on a long term evolution positioning protocol (LPP) between the LMF and the terminal device; and
transmit, to the LMF, the first location information of the terminal device;
wherein the first location information of the terminal device is determined based on at least one method of:
new radio enhanced cell identity (NR E-CID);
new radio downlink time difference of arrival (NR DL-TDOA);
new radio downlink angle-of-departure (NR DL-AoD); and
new radio multi-round trip time (NR Multi-RTT) positioning.

62. The terminal device of claim 60, wherein the processor is further configured to cause the terminal device to determine to perform a location verification in a case where a distance between the first location information of the terminal device and a current location of the terminal device is larger than a threshold.
